(19) United States
(12) Patent Application Publication
(10) Pub. No.: US 2022/0003571 A1
(43) Pub. Date: Jan. 6, 2022

(54) INFORMATION PROCESSING METHOD, NON-TRANSITORY COMPUTER READABLE MEDIUM, IN-VEHICLE APPARATUS, VEHICLE, INFORMATION PROCESSING APPARATUS, AND INFORMATION PROCESSING SYSTEM

(71) Applicant: TOYOTA JIDOSHA KABUSHIKI KAISHA, Toyota-shi (JP)

(72) Inventors: Yasuyuki KUSUMOTO, Nagoya-shi (JP); Yohei KUBO, Toyota-shi (JP); Katsuya MASUDA, Nakama-shi (JP); Kohei HOSOKAWA, Yukuhashi-shi (JP)

(73) Assignee: TOYOTA JIDOSHA KABUSHIKI KAISHA, Toyota-shi (JP)

(21) Appl. No.: 17/343,525

(22) Filed: Jun. 9, 2021

(30) Foreign Application Priority Data
Jul. 1, 2020 (JP) 2020-114498

(51) Int. Cl. G01C 21/00; G06K 9/00; G07C 5/00

(52) U.S. Cl. CPC G01C 21/3874; G01C 21/3822; G07C 5/008; G01C 21/3893; G06K 9/00791; G01C 21/3837

(57) ABSTRACT

An information processing method for a vehicle includes capturing and storing images of an area around the vehicle, and transmitting an image to an information processing apparatus when a judgment is made that a road on which the vehicle is traveling can no longer be identified by map matching, the image being captured at a time when the judgment is made.

### CROSS-REFERENCE TO RELATED APPLICATION

This application claims priority to Japanese Patent Application No. 2020-114498, filed on Jul. 1, 2020, the entire contents of which are incorporated herein by reference.

### TECHNICAL FIELD

The present disclosure relates to an information processing method, a program, an in-vehicle apparatus, a vehicle, an information processing apparatus, and an information processing system.

### BACKGROUND

Technology for transmitting images, captured while a vehicle is traveling, to a data center or the like and storing the images in the data center is known. For example, see patent literature (PTL) 1.

### CITATION LIST

### Patent Literature

PTL 1: JP 2019-101806 A

### SUMMARY

Transmitting all of the images captured while a vehicle is traveling leads to a large communication load. Furthermore, if all of the images captured while the vehicle is traveling are transmitted, a large amount of image data needs to be stored in a data center or the like.

Technology for transmitting images captured while a vehicle is traveling has room for improvement.

It would be helpful to improve technology for transmitting images captured while a vehicle is traveling.

An information processing method according to the present disclosure is an information processing method for a vehicle. The information processing method includes capturing and storing images of an area around the vehicle, and transmitting an image to an information processing apparatus when a judgment is made that a road on which the vehicle is traveling can no longer be identified by map matching, the image being captured at a time when the judgment is made.

A program according to the present disclosure is configured to cause a vehicle to execute operations including capturing and storing images of an area around the vehicle, and transmitting an image to an information processing apparatus when a judgment is made that a road on which the vehicle is traveling can no longer be identified by map matching, the image being captured at a time when the judgment is made.

An information processing method according to the present disclosure is an information processing method for an information processing apparatus configured to communicate with a vehicle. The information processing method includes performing image analysis, upon receiving an image of an area around the vehicle from the vehicle, on the image to judge whether there is a new road.

A program according to the present disclosure is configured to cause an information processing apparatus configured to communicate with a vehicle to execute operations including performing image analysis, upon receiving an image of an area around the vehicle from the vehicle, on the image to judge whether there is a new road.

An in-vehicle apparatus according to the present disclosure includes a memory configured to store images, captured by an imaging apparatus mounted in a vehicle, of an area around the vehicle, and a controller configured to transmit an image to an information processing apparatus when a judgment is made that a road on which the vehicle is traveling can no longer be identified by map matching, the image being captured at a time when the judgment is made.

An information processing apparatus according to the present disclosure includes a communication interface configured to communicate with a vehicle, and a controller configured to perform image analysis, upon receiving an image of an area around the vehicle from the vehicle, on the image to judge whether there is a new road.

According to the present disclosure, technology for transmitting images captured while a vehicle is traveling can be improved.

### BRIEF DESCRIPTION OF THE DRAWINGS

In the accompanying drawings:

FIG. 1 is a diagram illustrating a configuration of an information processing system according to an embodiment of the present disclosure;

FIG. 2 is a block diagram illustrating a configuration of a vehicle according to an embodiment of the present disclosure;

FIG. 3 is a block diagram illustrating a configuration of an information processing apparatus according to an embodiment of the present disclosure;

FIG. 4 is a diagram illustrating an example of when the road on which the vehicle is traveling can no longer be identified by map matching;

FIG. 5 is a flowchart illustrating operations of an information processing system according to an embodiment of the present disclosure; and

FIG. 6 is a flowchart illustrating operations of an information processing system according to an embodiment of the present disclosure.

### DETAILED DESCRIPTION

An embodiment of the present disclosure is described below with reference to the drawings.

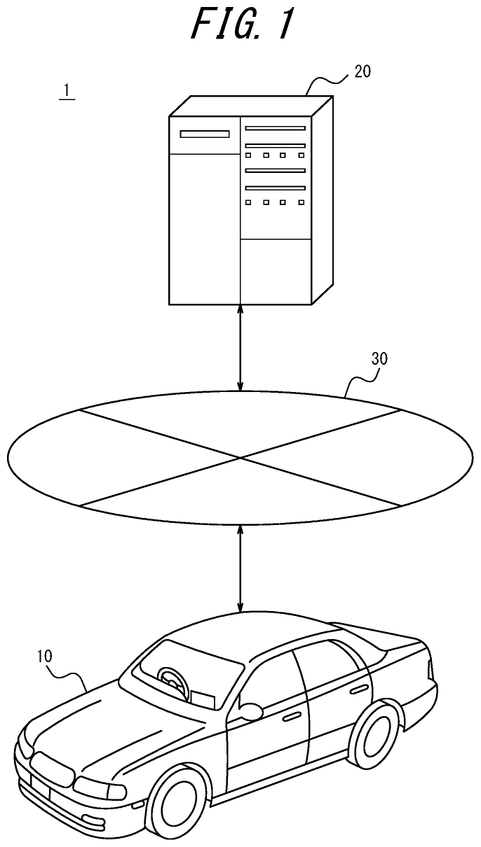

FIG. 1 is a diagram illustrating a configuration of an information processing system 1 according to an embodiment of the present disclosure. The configuration and outline of the information processing system 1 according to an embodiment of the present disclosure are described with reference to FIG. 1.

The information processing system 1 includes a vehicle 10 and an information processing apparatus 20. The vehicle 10 and the information processing apparatus 20 are communicably connected via a network 30. The network 30 may be a network including a mobile communication network, the Internet, and the like.

In FIG. 1, one each of the vehicle 10 and the information processing apparatus 20 are illustrated, but the number of vehicles 10 and information processing apparatuses 20 may be two or more of each.

The vehicle 10 is any type of automobile such as a gasoline-powered vehicle, a diesel-powered vehicle, a hybrid vehicle (HV), a plug-in hybrid vehicle (PHV), an electric vehicle (EV), or a fuel cell vehicle (FCV). The vehicle 10 is driven by a driver in the present embodiment, but the driving may be automated at any level. The level of automation is, for example, one of level 1 to level 5 in the level classification of the Society of Automotive Engineers (SAE). The vehicle 10 may be a dedicated Mobility as a Service (MaaS) vehicle.

The vehicle 10 continuously captures images of the area around the vehicle 10 during travel. The vehicle 10 captures images of the area around the vehicle 10 so that at least the area in front of the vehicle 10 appears in the images. The vehicle 10 may capture images of the area around the vehicle 10 so that, in addition to the area in front of the vehicle 10, the areas to the sides of the vehicle 10, the area behind the vehicle 10, and the like also appear in the images. Rather than transmitting all of the captured images to the information processing apparatus 20, the vehicle 10 transmits a captured image to the information processing apparatus 20 only when a predetermined condition is satisfied.

As a predetermined condition, the vehicle 10 transmits the captured images to the information processing apparatus 20 when the road on which the vehicle 10 is traveling can no longer be identified by map matching. Here, “map matching” refers to identifying the road on which the vehicle 10 is traveling in map data based on positional information on the vehicle 10, such as during navigation of the vehicle 10. Accordingly, when the road on which the vehicle 10 is traveling can no longer be identified by map matching, the vehicle 10 might be traveling on a new road that is not registered in the map data. In such cases, the vehicle 10 transmits images captured during a predetermined period, which includes the time when it is judged that the road on which the vehicle 10 is traveling can no longer be identified by map matching, to the information processing apparatus 20. This allows the vehicle 10 to transmit images of a new road not registered in the map data to the information processing apparatus 20 when the vehicle 10 begins to travel on the new road.

The information processing apparatus 20 is, for example, a dedicated computer configured to function as a server. The information processing apparatus 20 may be a general-purpose personal computer (PC). The information processing apparatus 20 can communicate with the vehicle 10 via the network 30.

The information processing apparatus 20 receives images, from the vehicle 10, captured while the vehicle 10 is traveling. The images received by the information processing apparatus 20 are images transmitted by the vehicle 10 when the predetermined condition is satisfied.

Upon receiving an image from the vehicle 10, the information processing apparatus 20 performs image analysis on the received image. The information processing apparatus 20 judges, by image analysis, whether a new road is included in the received image. Here, a “new road” is a road that is not registered in the map data that the vehicle 10 is using for map matching. When a new road is included in the image received from the vehicle 10, the information processing apparatus 20 can use information on the new road to update map data for navigation, for example. The information processing apparatus 20 may communicate the information on the new road to a plurality of vehicles 10 via the network 30. The plurality of vehicles 10 includes the vehicle 10 that has been transmitting images and other vehicles 10.

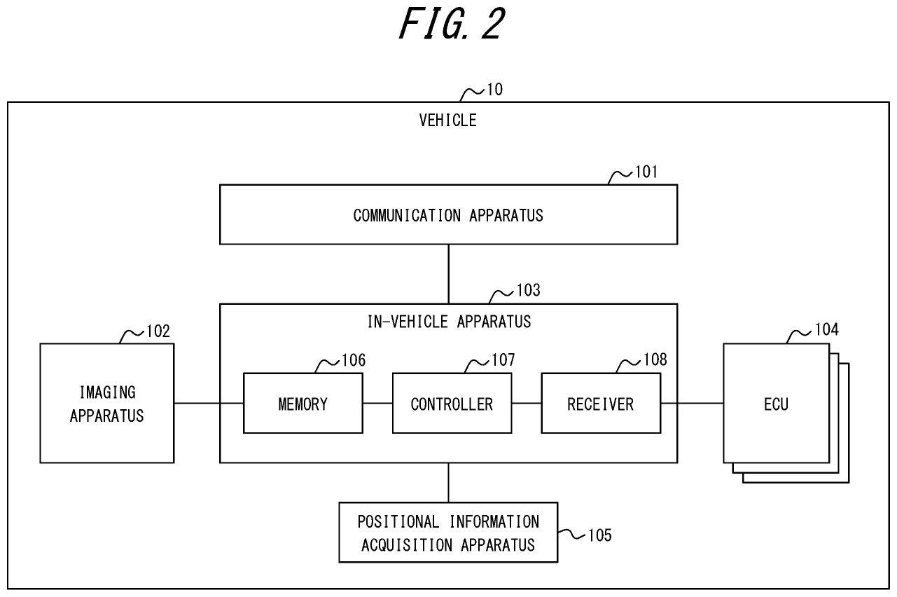

The configuration of the vehicle 10 according to an embodiment of the present disclosure is described with reference to FIG. 2.

The vehicle 10 includes a communication apparatus 101, an imaging apparatus 102, an in-vehicle apparatus 103, a plurality of electronic control units (ECUs) 104, and a positional information acquisition apparatus 105. The communication apparatus 101, the imaging apparatus 102, the in-vehicle apparatus 103, the plurality of ECUs 104, and the positional information acquisition apparatus 105 are, for example, communicably connected to each other via an in-vehicle network, such as a controller area network (CAN), or a dedicated line.

The communication apparatus 101 includes a communication module that connects to the network 30. For example, the communication apparatus 101 may include a communication module compliant with mobile communication standards such as long term evolution (LTE) and the 4th generation (4G) and the 5th generation (5G) standards. The vehicle 10 is connected to the network 30 via the communication apparatus 101. The communication apparatus 101 transmits and receives various information via the network 30. The communication apparatus 101 can communicate with the information processing apparatus 20 via the network 30.

The imaging apparatus 102 may, for example, be a camera. The imaging apparatus 102 can capture images of the area around the vehicle 10. The imaging apparatus 102 is installed on the vehicle 10 so as to be able to capture images of the area around the vehicle 10. The imaging apparatus 102 continuously captures images of the area around the vehicle 10 while the vehicle 10 is traveling. Although one imaging apparatus 102 is illustrated in FIG. 2, a plurality of imaging apparatuses 102 may be installed in the vehicle 10.

The in-vehicle apparatus 103 includes a memory 106, a controller 107, and a receiver 108. The in-vehicle apparatus 103 may, for example, be a navigation device. Alternatively, the in-vehicle apparatus 103 may, for example, be a multimedia device that includes navigation and audio functions.

The memory 106 is, for example, a semiconductor memory, a magnetic memory, an optical memory, or the like, but is not limited to these. The memory 106 may, for example, function as a main storage device, an auxiliary storage device, or a cache memory. The memory 106 stores any information used for operations of the in-vehicle apparatus 103. For example, the memory 106 may store system programs, application programs, and various information received by the communication apparatus 101. The information stored in the memory 106 may be updated with, for example, information received from the network 30 via the communication apparatus 101. A portion of the memory 106 may be installed externally to the in-vehicle apparatus 103. In that case, the externally installed portion of the memory 106 may be connected to the in-vehicle apparatus 103 via any appropriate interface.

The memory 106 stores images of the area around the vehicle 10 captured by the imaging apparatus 102. The memory 106 may store the images, captured by the imaging apparatus 102, of the area around the vehicle 10 only for a predetermined amount of time. For example, the memory 106 may be configured to store only 30 minutes' worth of images captured by the imaging apparatus 102. In this case, upon receiving a new image exceeding the 30 minutes' worth of images from the imaging apparatus 102, the memory 106 erases the oldest image and stores the new image.

The controller 107 includes at least one processor, at least one dedicated circuit, or a combination thereof. The processor is a general-purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 107 executes processes related to the operations of the in-vehicle apparatus 103 while controlling each part of the in-vehicle apparatus 103.

The receiver 108 receives various types of vehicle information relating to the vehicle 10 from the plurality of ECUs 104.

Each ECU 104 among the plurality of ECUs 104 collects various types of vehicle information relating to the vehicle 10 from various sensors mounted in the vehicle 10. The ECU 104 transmits the collected vehicle information to the receiver 108.

The vehicle information collected by the ECU 104 includes, for example, speed, acceleration, position, headlight status, autonomous driving status, and information indicating whether the road on which the vehicle 10 is traveling can be identified by map matching.

The positional information acquisition apparatus 105 includes at least one receiver corresponding to any appropriate satellite positioning system. For example, the positional information acquisition apparatus 105 may include a global positioning system (GPS) receiver. The positional information acquisition apparatus 105 acquires the measured value of the position of the vehicle 10 as the positional information. The positional information includes, for example, an address, a latitude, a longitude, an altitude, and the like.

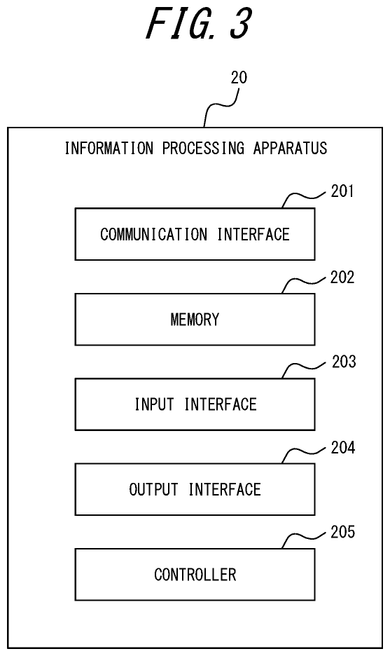

A configuration of the information processing apparatus 20 according to an embodiment of the present disclosure is described with reference to FIG. 3.

The information processing apparatus 20 includes a communication interface 201, a memory 202, an input interface 203, an output interface 204, and a controller 205.

The communication interface 201 includes a communication module connected to the network 30. For example, the communication interface 201 may include a communication module corresponding to a local area network (LAN). The information processing apparatus 20 is connected to the network 30 via the communication interface 201. The communication interface 201 transmits and receives various information via the network 30. The communication interface 201 can communicate with the vehicle 10 via the network 30.

The memory 202 is, for example, a semiconductor memory, a magnetic memory, an optical memory, or the like, but is not limited to these. The memory 202 may, for example, function as a main storage device, an auxiliary storage device, or a cache memory. The memory 202 stores any information used for operations of the information processing apparatus 20. For example, the memory 202 may store a system program, an application program, various types of information received by the communication interface 201, and the like. The information stored in the memory 202 may be updated with, for example, information received from the network 30 via the communication interface 201. A portion of the memory 202 may be installed externally to the information processing apparatus 20. In that case, the externally installed portion of the memory 202 may be connected to the information processing apparatus 20 via any appropriate interface.

The input interface 203 includes one or more input interfaces for detecting user input and acquiring input information based on user operation. For example, the input interface 203 includes, but is not limited to, a physical key, a capacitive key, a touch screen integrally provided with a display of the output interface 204, or a microphone that accepts audio input.

The output interface 204 includes one or more output interfaces for outputting information to notify the user. For example, the output interface 204 includes, but is not limited to, a display for outputting information as video or a speaker for outputting information as audio.

The controller 205 includes at least one processor, at least one dedicated circuit, or a combination thereof. The processor is a general-purpose processor, such as a CPU or a GPU, or a dedicated processor that is dedicated to specific processing. The dedicated circuit is, for example, an FPGA or an ASIC. The controller 205 executes processes related to the operations of the information processing apparatus 20 while controlling each part of the information processing apparatus 20.

(Operations of Information Processing System)

Operations of the information processing system 1 illustrated in FIG. 1 is described with reference to FIGS. 1 to 3.

The imaging apparatus 102 of the vehicle 10 continuously captures images of the area around the vehicle 10 while the vehicle 10 is traveling. The images captured by the imaging apparatus 102 may be still images or a moving image. In the case of still images, the imaging apparatus 102 successively captures still images at predetermined time intervals.

The memory 106 of the in-vehicle apparatus 103 stores images of the area around the vehicle 10 captured by the imaging apparatus 102 while the vehicle 10 is traveling.

While the vehicle 10 is traveling, the receiver 108 continuously receives information indicating whether the road on which the vehicle 10 is traveling can be identified by map matching from the ECU 104 that collects the information. The receiver 108 outputs the information, received from the ECU 104, indicating whether the road on which the vehicle 10 is traveling can be identified by map matching to the controller 107. The controller 107 acquires the information indicating whether the road on which the vehicle 10 is traveling can be identified by map matching from the receiver 108.

While the vehicle 10 is traveling, the receiver 108 continuously receives information on the position of the vehicle 10 from the positional information acquisition apparatus 105. The receiver 108 outputs the information, received from the positional information acquisition apparatus 105, on the position of the vehicle 10 to the controller 107. The controller 107 acquires the information on the position of the vehicle 10 from the receiver 108. The controller 107 may acquire the information on the position of the vehicle 10 directly from the positional information acquisition apparatus 105.

The controller 107 judges whether the road on which the vehicle 10 is traveling can be identified by map matching based on the information, acquired from the receiver 108, indicating whether the road on which the vehicle 10 is traveling can be identified by map matching.

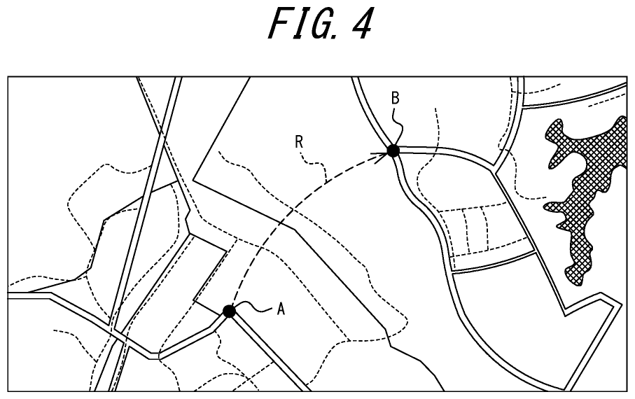

FIG. 4 illustrates an example of when the road on which the vehicle 10 is traveling can no longer be identified by map matching. In FIG. 4, the vehicle 10 is assumed to travel from point A to point B along route R. In the example illustrated in FIG. 4, the road corresponding to route R is not registered in the map data used by the vehicle 10. If the vehicle 10 attempts to enter route R from point A, then the ECU 104 that collects information indicating whether the road on which the vehicle 10 is traveling can be identified by map matching acquires information indicating that the road on which the vehicle 10 is traveling cannot be identified by map matching. When the vehicle 10 reaches point B, the ECU 104 that collects information indicating whether the road on which the vehicle 10 is traveling can be identified by map matching acquires information indicating that the road on which the vehicle 10 is traveling can be identified by map matching.

When the controller 107 judges, based on the information acquired from the receiver 108, that the road on which the vehicle 10 is traveling can no longer be identified by map matching, the controller 107 transmits images captured by the imaging apparatus 102 during a predetermined period that includes the time when the judgment was made to the information processing apparatus 20 via the communication apparatus 101. The predetermined period may be any appropriate period set in advance.

The predetermined period may, for example, be 10 seconds before and after the time when it is judged that the road on which the vehicle 10 is traveling can no longer be identified by map matching. In this case, the controller 107 transmits images captured in the 10 seconds before the judgment that the road on which the vehicle 10 is traveling can no longer be identified by map matching, and images captured in the 10 seconds after the judgment that the road on which the vehicle 10 is traveling can no longer be identified by map matching, to the information processing apparatus 20 via the communication apparatus 101.

When the controller 107 transmits the images captured by the imaging apparatus 102 during the predetermined period that includes the time when it was judged that the road on which the vehicle 10 is traveling can no longer be identified by map matching, the controller 107 may also transmit the information on the position of the vehicle 10, acquired during the predetermined period, to the information processing apparatus 20 via the communication apparatus 101.

The communication interface 201 of the information processing apparatus 20 receives the images transmitted by the vehicle 10. The memory 202 stores the images received by the communication interface 201.

The controller 205 performs image analysis with respect to the images acquired from the vehicle 10. The controller 205 performs image analysis on the images acquired from the vehicle 10 to judge whether there is a new road that is not registered in the map data used by the vehicle 10.

When it is judged as a result of the image analysis that there is a new road, the controller 205 can, for example, use information on the new road to update map data for navigation. The controller 205 may, for example, judge whether a new road is included in an image acquired from the vehicle 10 based on a learning model learned through machine learning.

When the controller 205 judges that there is a new road not registered in the map data, the controller 205 may communicate the existence of the new road to a plurality of vehicles 10 via the network 30. The plurality of vehicles 10 includes the vehicle 10 that has been transmitting images and other vehicles 10. This enables the vehicle 10 that can communicate with the network 30 to acquire, in real time, information indicating the existence of a new road that is not registered in the map data.

In the present embodiment, when a condition that the road on which the vehicle 10 is traveling can no longer be identified by map matching is satisfied, the controller 107 transmits images captured in a predetermined period that includes the time when the condition is satisfied to the information processing apparatus 20. The memory 106 may store a condition description file that describes such a condition. In this case, the controller 107 refers to the condition described in the condition description file stored in the memory 106, and when it is judged that the condition is satisfied, the controller 107 transmits the images captured during the predetermined period that includes the time when the judgment was made to the information processing apparatus 20. When the controller 107 includes a storage area, the condition description file may be stored in the storage area of the controller 107.

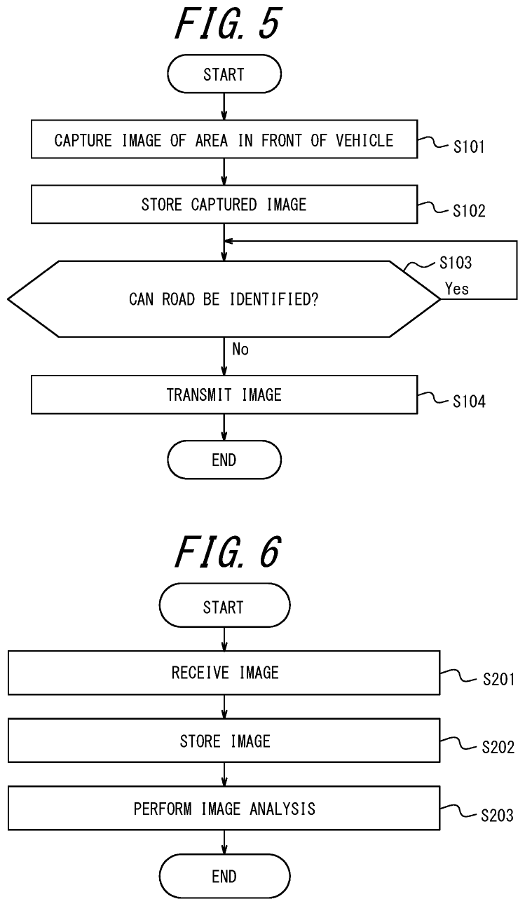

Operations of the information processing system 1 are described with reference to the flowchart in FIGS. 5 and 6. FIG. 5 is a flowchart illustrating operations of the vehicle 10. FIG. 6 is a flowchart illustrating operations of the information processing apparatus 20.

First, operations of the vehicle 10 are described with reference to FIG. 5.

In step S101, the imaging apparatus 102 of the vehicle 10 continuously captures images of the area around the vehicle 10 while the vehicle 10 is traveling.

In step S102, the memory 106 of the in-vehicle apparatus 103 stores the images, of the area around the vehicle 10, that the imaging apparatus 102 continuously captures while the vehicle 10 is traveling.

In step S103, the controller 107 of the in-vehicle apparatus 103 judges whether the road on which the vehicle 10 is traveling can be identified by map matching. When it is judged that the road on which the vehicle 10 is traveling can be identified by map matching, i.e., when step S103 is judged to be Yes, the controller 107 repeats the process of step S103. When it is judged that the road on which the vehicle 10 is traveling can no longer be identified by map matching, i.e., when step S103 is judged to be No, the controller 107 proceeds to step S104.

In step S104, the controller 107 transmits images, captured by the imaging apparatus 102 during a predetermined period that includes the time when the judgment was made that the road on which the vehicle 10 is traveling can no longer be identified by map matching, to the information processing apparatus 20 via the communication apparatus 101.

Next, operations of the information processing apparatus 20 are described with reference to FIG. 6.

In step S201, the communication interface 201 of the information processing apparatus 20 receives the images transmitted by the vehicle 10 in step S104 of FIG. 5.

In step S202, the memory 202 of the information processing apparatus 20 stores the images received by the communication interface 201.

In step S203, the controller 205 of the information processing apparatus 20 performs image analysis on the images received from the vehicle 10. When it is judged, as a result of image analysis, that a new road is included in a received image, the controller 205 may communicate the existence of the new road to a plurality of vehicles 10 via the network 30.

When it is judged, in the information processing method according to the present embodiment, that the road on which the vehicle 10 is traveling can no longer be identified by map matching, the vehicle 10 transmits images captured when the judgment was made to the information processing apparatus 20, as described above. In this way, in the information processing method according to the present embodiment, the vehicle 10 does not transmit all of the images captured during travel to the information processing apparatus 20, but rather only transmits captured images to the information processing apparatus 20 when a predetermined condition is satisfied. The information processing method according to the present embodiment can thereby reduce the communication load between the vehicle 10 and the information processing apparatus 20. Furthermore, in the information processing method according to the present embodiment, the capacity necessary for the memory 202 of the information processing apparatus 20 to store the images captured by the vehicle 10 can be reduced. The information processing method according to the present embodiment can therefore improve technology for transmitting images captured while the vehicle 10 is traveling.

The present disclosure is not limited to the embodiments described above. For example, a plurality of blocks described in the block diagrams may be integrated, or a block may be divided. Instead of executing the plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the vehicle 10 in the above embodiment may be executed in the information processing apparatus 20. Also, some of the processing operations executed in the information processing apparatus 20 in the above embodiment may be executed in the vehicle 10.

For example, a configuration that causes a general purpose electronic device such as a smartphone, a computer, or the like to function as the information processing apparatus 20 according to the embodiment described above is possible. Specifically, a program containing processes for realizing the functions of the information processing apparatus 20 or the like according to an embodiment may be stored in a memory of the electronic device, and the program may be read and executed by a processor of the electronic device. Accordingly, in an embodiment, the present disclosure can also be implemented as a program executable by a processor.

1. An information processing method for a vehicle, the information processing method comprising:
capturing and storing images of an area around the vehicle; and
transmitting an image to an information processing apparatus when a judgment is made that a road on which the vehicle is traveling can no longer be identified by map matching, the image being captured at a time when the judgment is made.

2. The information processing method of claim 1, wherein the transmitting comprises transmitting, to the information processing apparatus, images captured during a predetermined period that includes the time when the judgment is made.

3. The information processing method of claim 1, further comprising:
transmitting to the information processing apparatus, when the judgment is made, images captured by a time when the road on which the vehicle is traveling can be identified by map matching.

4. The information processing method of claim 1, further comprising:
transmitting information on a position of the vehicle together with the image to the information processing apparatus.

5. The information processing method of claim 1, wherein the image is a moving image.

6. A non-transitory computer readable medium storing a program configured to cause the vehicle to execute the information processing method of claim 1.

7. The non-transitory computer readable medium of claim 6, wherein the transmitting comprises transmitting, to the information processing apparatus, images captured during a predetermined period that includes the time when the judgment is made.

8. The non-transitory computer readable medium of claim 6, wherein the information processing method further comprises transmitting to the information processing apparatus, when the judgment is made, images captured by a time when the road on which the vehicle is traveling can be identified by map matching.

9. The non-transitory computer readable medium of claim 6, wherein the information processing method further comprises transmitting information on a position of the vehicle together with the image to the information processing apparatus.

10. The non-transitory computer readable medium of claim 6, wherein the image is a moving image.

11. An information processing method for an information processing apparatus configured to communicate with a vehicle, the information processing method comprising
performing image analysis, upon receiving an image of an area around the vehicle from the vehicle, on the image to judge whether there is a new road.

12. A non-transitory computer readable medium storing a program configured to cause the information processing apparatus to execute the information processing method of claim 11.

13. An in-vehicle apparatus comprising:
a memory configured to store images, captured by an imaging apparatus mounted in a vehicle, of an area around the vehicle; and
a controller configured to transmit an image to an information processing apparatus when a judgment is made that a road on which the vehicle is traveling can no longer be identified by map matching, the image being captured at a time when the judgment is made.

14. The in-vehicle apparatus of claim 13, wherein the controller is configured to transmit, to the information processing apparatus, images captured during a predetermined period that includes the time when the judgment is made.

15. The in-vehicle apparatus of claim 13, wherein the controller is configured to transmit to the information processing apparatus, when the judgment is made, images captured by a time when the road on which the vehicle is traveling can be identified by map matching.

16. The in-vehicle apparatus of claim 13, wherein the controller is configured to transmit information on a position of the vehicle together with the image to the information processing apparatus.

17. The in-vehicle apparatus of claim 13, wherein the image is a moving image.

18. A vehicle comprising the in-vehicle apparatus of claim 13.

19. An information processing apparatus comprising:
a communication interface configured to communicate with the in-vehicle apparatus of claim 13; and
a controller configured to perform image analysis, upon receiving an image of the area around the vehicle from the vehicle, on the image to judge whether there is a new road.

20. An information processing system comprising:
the in-vehicle apparatus of claim 13; and
an information processing apparatus comprising:
a communication interface configured to communicate with the in-vehicle apparatus; and
a controller configured to perform image analysis, upon receiving an image of the area around the vehicle from the vehicle, on the image to judge whether there is a new road.
